(19) United States
(12) Patent Application Publication
(10) Pub. No.: US 2016/0220903 A1
(43) Pub. Date: Aug. 4, 2016

(54) Systems and Methods for Dynamically Creating Personalized Storybooks based on User Interactions within a Virtual Environment

(71) Applicant: Kuato Games (UK) Limited, London (GB)

(72) Inventors: David Miller, London (GB); Mark Horneff, London (GB); Chris Liu, London (GB); Scott Lamb, Enfield (GB); Kris Turvey, London (GB)

(21) Appl. No.: 14/612,129

(22) Filed: Feb. 2, 2015

(51) Int. Cl. A63F 13/537

(52) U.S. Cl. CPC A63F 13/537

(57) ABSTRACT

The method creates storybooks corresponding to user interactions with a virtual game environment. A computing device receives user input to control actions of a virtual character within a virtual game environment and records, without user input, a temporal sequence of events from the virtual game environment. Each event represents an interaction of the virtual character with the virtual game environment, and each event includes a respective image and respective text describing the respective event. Subsequent to the recording, the user is presented with a sequence of simulated pages corresponding to the sequence of events. Each simulated page includes the respective recorded image for a respective event and includes the respective text describing the event. For at least a subset of the simulated pages, the user modifies the respective text. An output file is generated that includes the sequence of simulated pages as modified by the user.

### TECHNICAL FIELD

Some embodiments relate to printing personalized storybooks, and more specifically to printing storybooks that are created based on user interactions within a virtual environment.

### BACKGROUND

People interact with virtual environments such as video games or massively-multiplayer online games. A participant's client device, or computer, typically accesses a computer-simulated world, and presents perceptual stimuli to the user. Users can operate their client devices or computer input/output (I/O) devices to manipulate elements of the game world. For example, a user may identify with a character and move that character within the game to interact with elements in the environment. These elements may include non-player characters and other users' characters. When a user or participant interacts with an element of the game, the rendering of the game is updated to represent its new internal state.

Some details of the user interactions may be encapsulated in logs that are later used in debugging or other forms of reactive software development. These logs are not accessible to the user of the game and their format is not intended to be readable by the user.

In some cases, users find it useful to capture still or moving images of a video game. For example, a user may find it useful to have a still image of an interaction for reflection, review, or sharing with friends, family, or others. Current mechanisms and techniques for grabbing images rely on screen grab or screen capture software on the user's computing device. Such screen grab mechanisms capture the contents of a device's screen, a window, or the user's desktop into a picture (or video) file that can later be opened using image preview applications. Hence, present capture mechanisms for use in video games require initiation by the user of the client device and rely on software installed on the computing device.

### SUMMARY

Implementations disclosed herein address the above deficiencies and other problems associated with providing video game users narrative representations of their interactions with the game. Images are captured by the video game itself, associated with narrative text, and presented as a sequence. The user can adapt the narrative text and/or images to create a customized story that represents the game play.

In accordance with some implementations, a method is provided that creates storybooks corresponding to user interactions with a virtual game environment. The method is performed at a computing device having one or more processors and memory storing one or more programs configured for execution by the one or more processors. The computing device receives user input to control actions of a virtual character within the virtual game environment and records, without user input, a temporal sequence of events from the game environment. Each event represents an interaction of the virtual character with the game environment, and each event includes a respective image and respective text describing the respective event. Subsequent to the recording, the computing device presents to the user a sequence of simulated pages corresponding to the sequence of events. Each simulated page includes at least a portion of the respective recorded image for a respective event and includes at least a portion of the respective text describing the event. For at least a subset of the simulated pages, the computing device receives user input to modify at least a portion of the respective text. The computing device generates a file that includes the sequence of simulated pages as modified by the user.

In some implementations, the method includes facilitating a printing of the file to create a tangible book, which includes the simulated pages as modified by the user.

In some implementations, the file has a file type that is one of JPEG, TIFF, BMP, PNG, PDF, EPUB, or MOBI.

In some implementations, the method includes transmitting the file to a remote book printing provider with instructions to ship a bound book corresponding to the file to a specified geographic address.

Generally, the method includes displaying the virtual game environment and the virtual character on a display device associated with the computing device. In some implementations, displaying the virtual game environment includes displaying respective narrative text corresponding to a respective displayed virtual scene. In some implementations, the method includes receiving user activation of a user interface control to include the respective narrative text with a first event. The activation occurs during user interaction with the virtual game environment. In some instances, at least a portion of the respective narrative text is included in a simulated page corresponding to the first event.

In some implementations, the virtual character is a sentient being within the virtual game environment. In some implementations, the user can choose a virtual character to represent herself/himself. In some implementations, the user can specify various characteristics of the selected virtual character, such as gender, age, size, clothing or skin tone, and so on.

In some implementations, a first event includes two or more images. In some of these implementations, the first event corresponds to a first simulated page, and the first simulated page includes the two or more respective images. In other implementations, the first event corresponds to a plurality of simulated pages, and each simulated page in the plurality of simulated pages includes a respective one of the two or more images.

In some implementations, the respective text for a second simulated page includes a plurality of text options, and the user selects one of the plurality of text options. In some implementations, alternative text options are provided for specific words or phrases rather than the entire respective text as a whole.

In some implementations where an event includes multiple images, the event corresponds to a first simulated page, and the multiple images are presented to the user for user selection. In some implementations, while presenting the first simulated page to the user, the plurality of images are presented as alternative options for the first simulated page and the user selects one (or more) of the plurality of images. The selected image (or multiple images) for the first simulated page are included in the generated file.

In some implementations, the method includes receiving a user-provided name for the virtual character, and the user-provided name is included in the respective text on one or more of the simulated pages. In some implementations, the user-provided name identifies the virtual character. In some implementations, the user may provide other attributes for the virtual character, such as gender, age, or other physical attributes.

In some implementations, each event includes a respective caption, distinct from the respective text describing the respective event, and the respective caption is displayed accompanying the respective image in a respective simulated page. In some implementations, the additional caption is editable, but in other implementations it is immutable.

In some implementations, a third event includes one or more labels that identify locations within the virtual game environment when the third event is recorded, and the one or more labels are displayed on a third simulated page to identify the locations.

In some implementations, a fourth event includes data that identifies a state of the virtual game environment when the fourth event is recorded, and the data is displayed on a fourth simulated page to convey the state of the virtual game environment.

In some implementations, a fifth event includes one or more labels that identify other virtual characters or virtual objects within the virtual game environment when the fifth event is recorded, and the one or more labels are displayed on a fifth simulated page to identify the other virtual characters or virtual objects.

In some implementations, a sixth event includes a conversation between the virtual character and one or more other virtual characters within the virtual game environment at the time the sixth event is recorded, and the conversation is displayed in a textual format on a sixth simulated page. In some implementations, the virtual character can have a conversation with a virtual assistant or virtual object as well.

In some implementations, a seventh event includes one or more labels that identify virtual objects collected by the virtual character when the seventh event is recorded, and the one or more labels are displayed on a seventh simulated page to identify the objects.

In some implementations, an eighth event includes one or more labels that identify achievements of the virtual character when the eighth event is recorded, and the one or more labels are displayed on a eighth simulated page to identify the achievements.

In some implementations, a first event includes one or more labels that identify current game data at the time the first event is recorded. The current game data includes one or more of: named locations within the virtual game environment; a state of the virtual game environment; other virtual characters or virtual objects within the virtual game environment; virtual objects collected by the virtual character; and achievements of the virtual character. The one or more labels are displayed on a first simulated page corresponding to the first event.

In some implementations, the sequence of simulated pages includes one or more simulated pages that include graphics that are one or more of: a map of at least a portion of the virtual game environment, including a path on the map showing movement of the virtual character within the virtual game environment; a photograph of the user taken by a photo sensor associated with the computing device, where the photograph is taken during the user's interaction with the virtual game environment; an image of virtual objects collected by the virtual character; and an image depicting a certificate of achievement of the virtual character in the virtual game environment.

In some implementations, one or more simulated pages include multimedia attachments that are one or more of: a video clip from the virtual game environment; an audio clip from the virtual game environment; a video clip of the user interacting with the virtual game environment; and an audio clip of the user interacting with the virtual game environment.

In some implementations, at least a subset of the events are automatically recorded, without human intervention, when the virtual character reaches a milestone in the virtual game environment.

In some implementations, a system is provided that creates storybooks corresponding to user interactions with a virtual game environment. The system includes one or more processors and memory storing one or more programs configured for execution by the one or more processors. The system receives user input to control actions of a virtual character within the virtual game environment and records, without user input, a temporal sequence of events from the game environment. Each event represents an interaction of the virtual character with the game environment, and each event includes a respective image and respective text describing the respective event. Subsequent to the recording, the system presents to the user a sequence of simulated pages corresponding to the sequence of events. Each simulated page includes at least a portion of the respective recorded image for a respective event and includes at least a portion of the respective text describing the event. For at least a subset of the simulated pages, the system receives user input to modify at least a portion of the respective text. The system generates a file that includes the sequence of simulated pages as modified by the user.

In some implementations, a system is provided that performs any of the method steps listed above.

In some implementations, a non-transitory computer readable storage medium is provided that stores programs for creating storybooks corresponding to user interactions with a virtual game environment. The computer readable storage medium stores one or more programs configured for execution by a computing device. The programs are configured to receive user input to control actions of a virtual character within the virtual game environment and to record, without user input, a temporal sequence of events from the game environment. Each event represents an interaction of the virtual character with the game environment, and each event includes a respective image and respective text describing the respective event. Subsequent to the recording, the programs are configured to present to the user a sequence of simulated pages corresponding to the sequence of events. Each simulated page includes at least a portion of the respective recorded image for a respective event and includes at least a portion of the respective text describing the event. The programs are configured to receive user input to modify at least a portion of the respective text. The programs are configured to generate a file that includes the sequence of simulated pages as modified by the user.

In some implementations, a non-transitory computer readable storage medium is provided that stores one or more programs. The one or more programs include instructions for performing any of the method steps above.

In some implementations, a video game records the interactions between a user and elements of the game in the form of events. The events encapsulate the metadata, descriptions, editable captions, and images of the user (the user's character) interacting with the game. The sequence of recorded events is then presented to the user, for example, following the completion of one or more sessions in the game. Each event caption takes the form of a brief narrative describing the user's interaction, or the interaction of the game character. In some implementations, the user is then provided with options to change words in the captions using a set of provided alternatives. In some instances, the alternatives include synonyms or antonyms provided by the developer of the game. For example, in a caption such as “The robot ran down the corridor quickly,” the alternatives offered to the user for “ran down,” “corridor,” and “quickly” may respectively include: “trundled along,” “passed through,” “fell down,” and “waddled along;” “passageway,” “hallway,” “tunnel,” and “shaft;” “swiftly,” “slowly,” “rapidly,” and “clumsily.”

The user may indicate that the recording of events should be transformed into a commonly-used digital printable format (e.g., ePub) so that a hard copy (e.g., a book) may be created for printing or sharing with others via digital and electronic communication mechanisms. The printable format includes a sequence of renderings of the events in the form of narrative text, images, and other details derived from the events. The rendering of the hard copy may be a conventional hard-copy book including such notions as front and back covers, bindings and so on. The user is given the option to specify other attributes for the book, such as title, author, and date, which are rendered on appropriate elements of the digital book (e.g., the front cover).

The recording methods and systems described herein provide numerous benefits and advantages over prior recording mechanisms. For example, in a learning context, users are able to reflect on their interactions within the game and construct narratives that best suits their experience. Furthermore, because the narrative representation is situated and accessed from within the game, it provides a deeper connection to the user's learning experience. Prior techniques would only support recording images from one scene in a video game, without the benefit of a narrative complement to these images. In other words, the user's learning experience within the game is enriched by the storybook mechanism.

In some implementations, the user is able to view a sequence of captioned images that represent interaction within the game. The user can personalize captions associated with these images, thereby forming a personalized narrative representation of the interactions. This representation may be separated into sections, such as chapters, and can be accessed and manipulated from within the game. The narrative representation is available in a printable form, and can be shared with others using commonly available electronic digital communications tools.

Thus methods and systems are provided that dynamically create personalized storybooks based on user interactions within a virtual environment.

### BRIEF DESCRIPTION OF THE DRAWINGS

For a better understanding of the aforementioned implementations of the invention as well as additional implementations thereof, reference should be made to the Description of Implementations below, in conjunction with the following drawings in which like reference numerals refer to corresponding parts throughout the figures.

FIG. 1 is a block diagram illustrating a context in which some implementations operate.

FIG. 2 is a block diagram of a computing device according to some implementations.

FIG. 3 illustrates how scenes from a video game interaction are recorded according to some implementations.

FIG. 4 illustrates how recorded events are used to create storybook pages according to some implementations.

FIGS. 5A-5F provide a flowchart of a process, performed at a computing device, for building a storybook of interacting with a virtual environment according to some implementations.

FIGS. 6A-6L are screenshots from one implementation.

Reference will now be made to implementations, examples of which are illustrated in the accompanying drawings. In the following description, numerous specific details are set forth in order to provide a thorough understanding of the present invention. However, it will be apparent to one of ordinary skill in the art that the present invention may be practiced without these specific details.

### DESCRIPTION OF IMPLEMENTATIONS

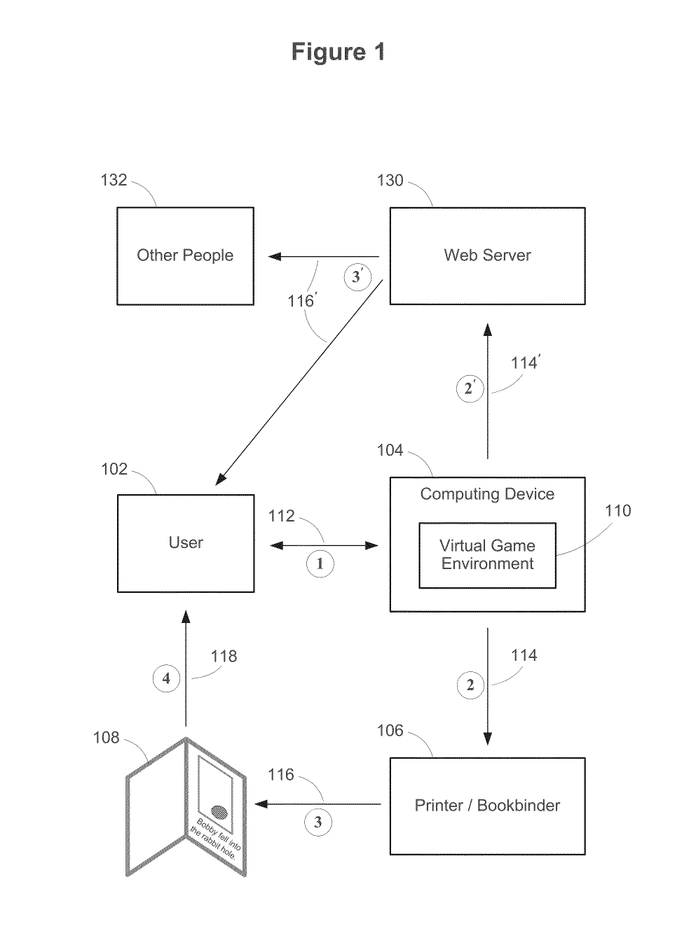

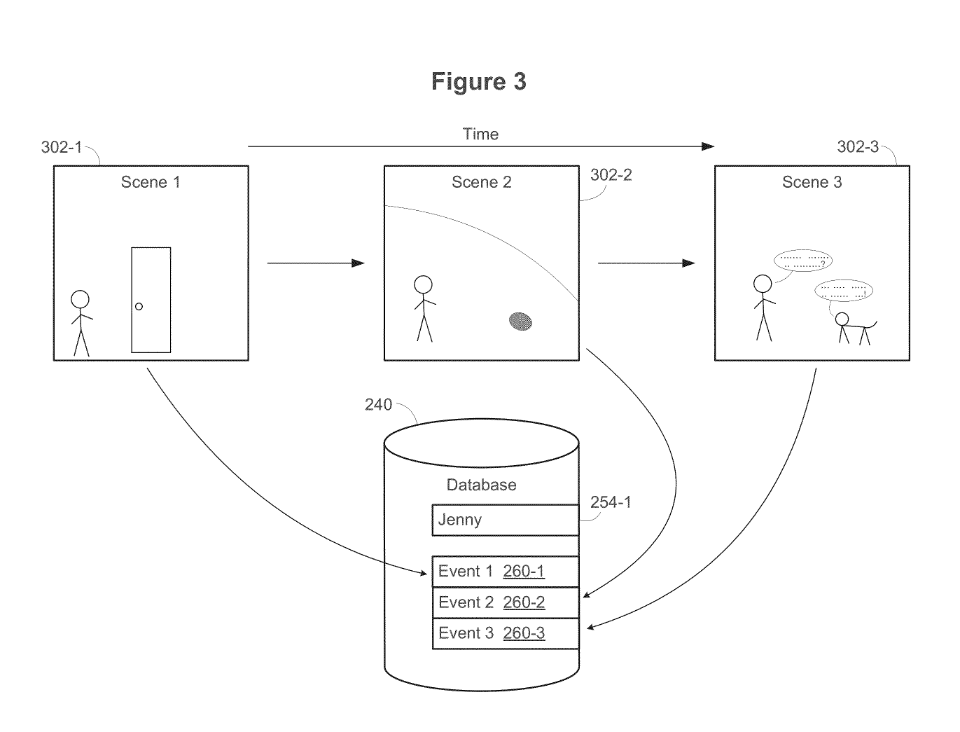

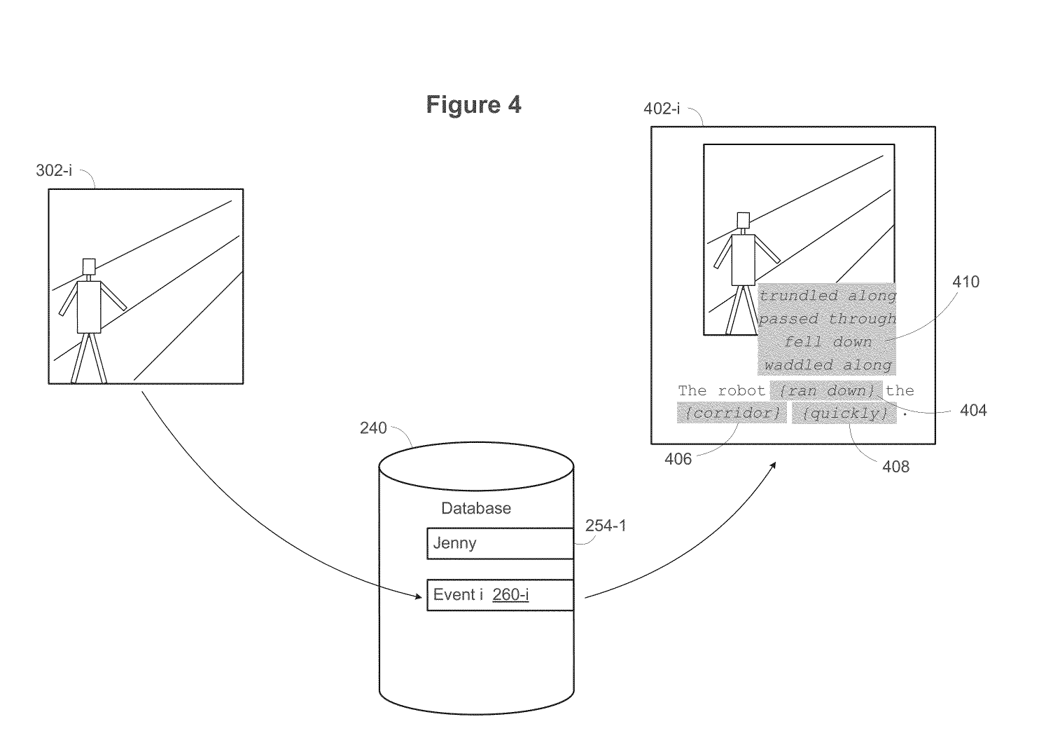

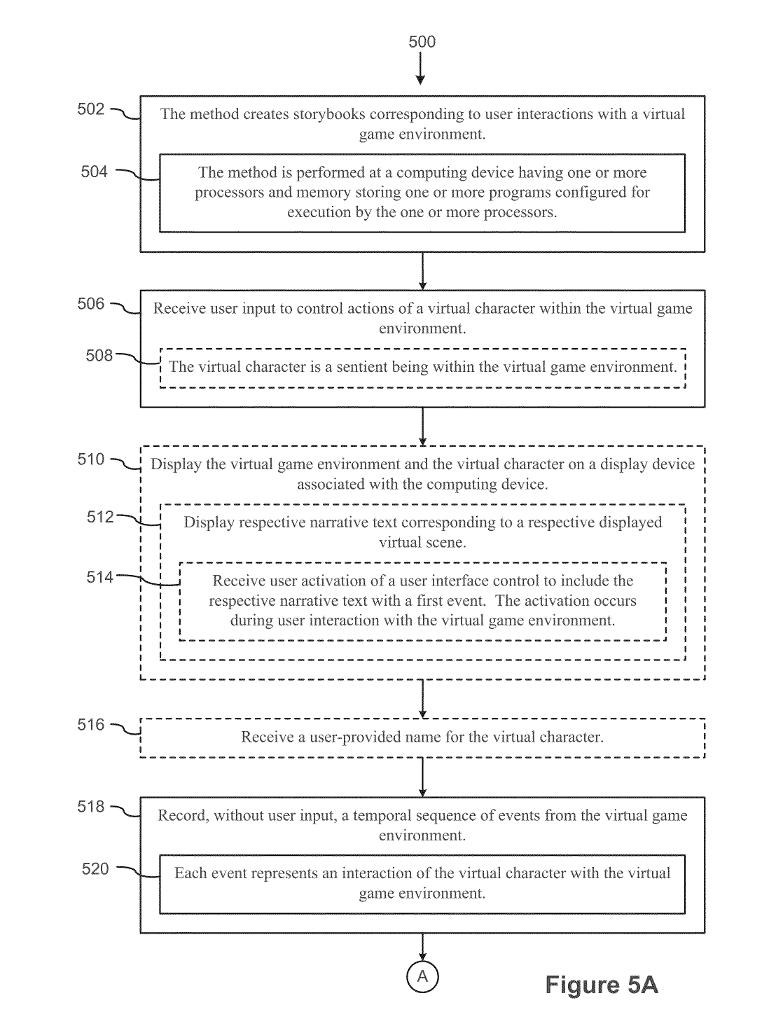

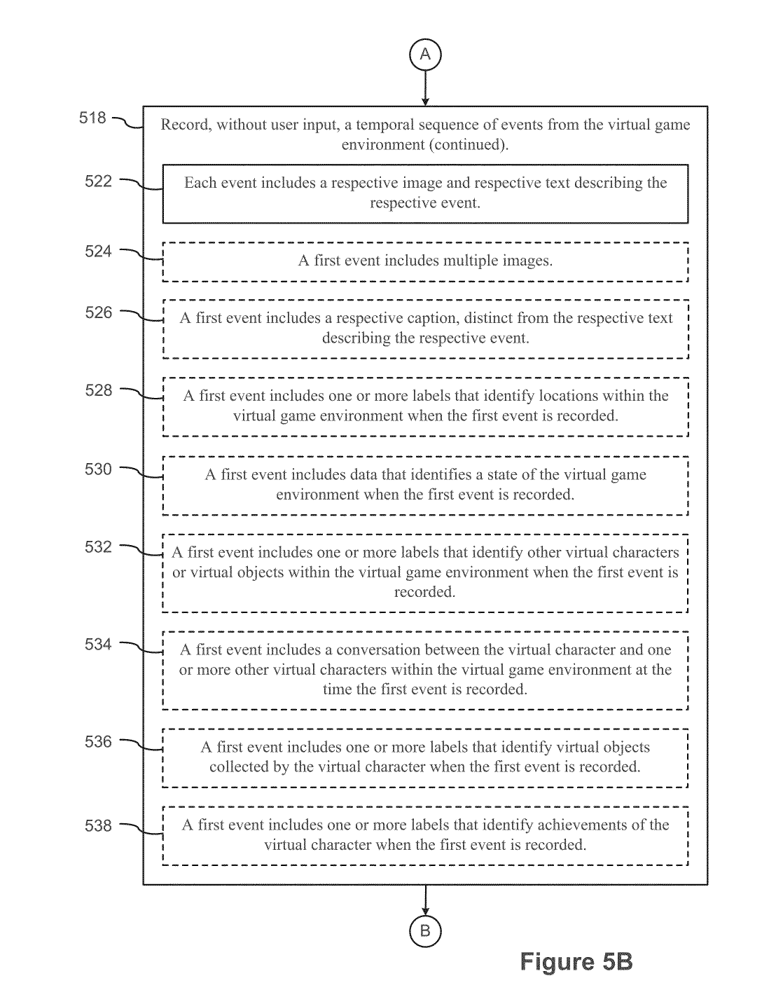

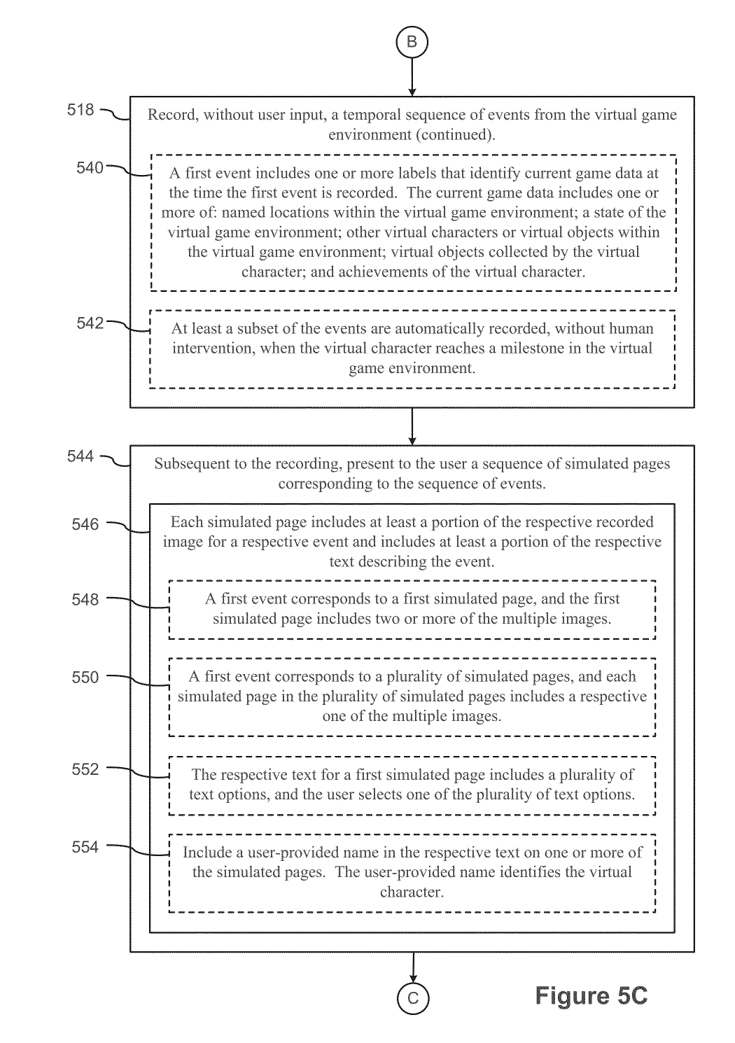

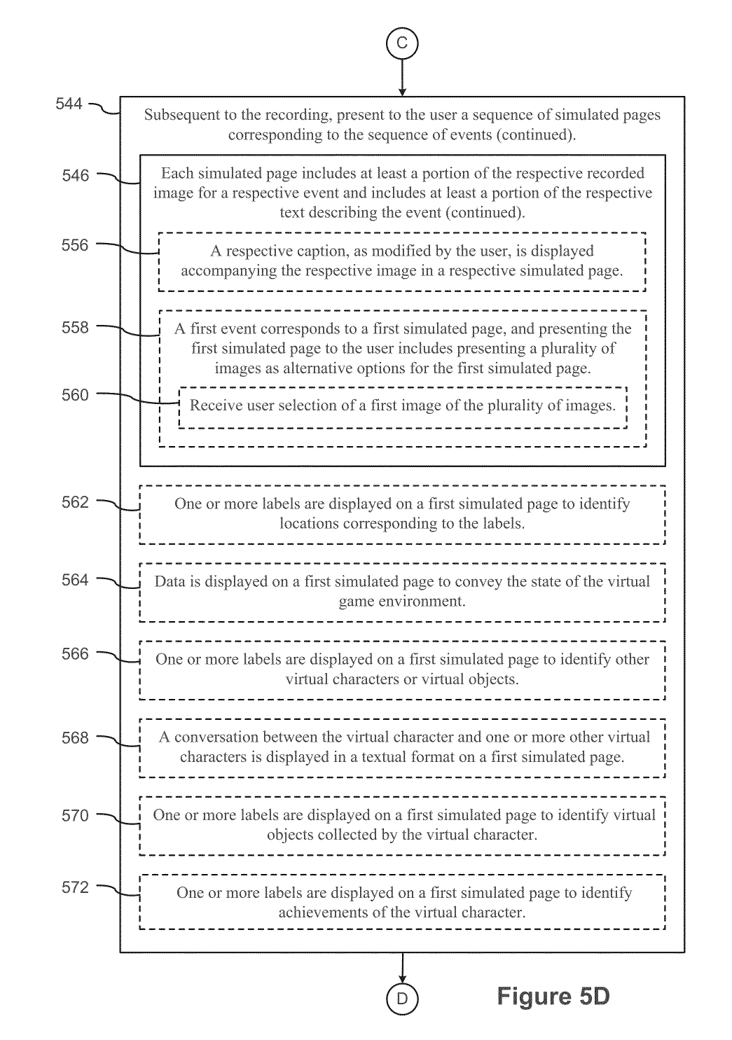

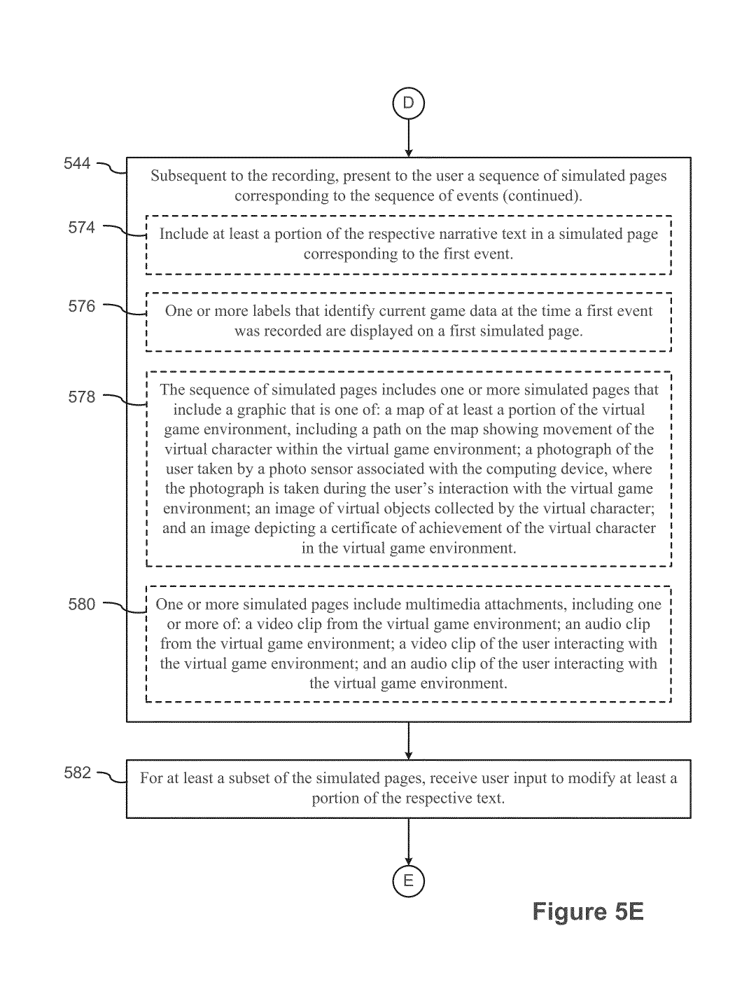

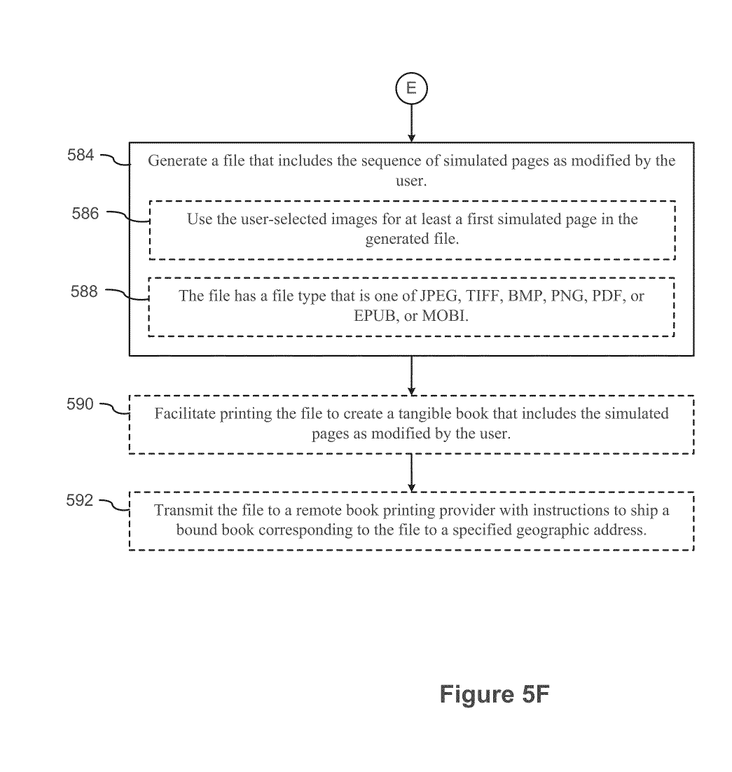

FIG. 1 is a block diagram illustrating conceptually a context in which some implementations operate. As illustrated, a user 102 interacts (112) with a virtual game environment 110 that is executed at a computing device 104. During game play, events are recorded from the virtual game environment, as illustrated below with respect to FIG. 3. From the recorded events, pages are created that include both recorded images and text. This is illustrated below with respect to FIGS. 4 and 5A-5F. In some implementations, the virtual game environment 110 is provided by software (e.g., a game application 222) running locally on the user's computing device 104. In some implementations, the virtual game environment 110 is displayed locally on the user's computing device 104, but some of the software is running on a remote server (e.g., in the cloud).

After the digital book is created, it may be sent (114) to a printer or bookbinder 106, which prints/binds (116) a tangible book 108 that corresponds to the user's interaction with the virtual game environment 110. The tangible book 108 may be shipped (118) to the user 102 or to any other person, such as a friend or relative.

In some instances, the digital book is distributed electronically instead of, or in addition to, creating a tangible book 108. In some implementations, the digital book may be read electronically, either using an eBook reader or other software application. In some implementations, a book file 226 is transmitted (114′) to a web server 130, which can store and distribute the digital book to the original user 102 or to other people 132, such as friends and relatives. In some implementations, the digital book itself is distributed (116′) (e.g., as an ePub or PDF), which can then be viewed on the recipient's computing device. In some implementations, the digital book is stored only at the web server, and users access the digital book over a network. For example, the user 102 may send a link to other people 132, and clicking on the links directs the recipient's browser to the web server 130 where the digital book is stored.

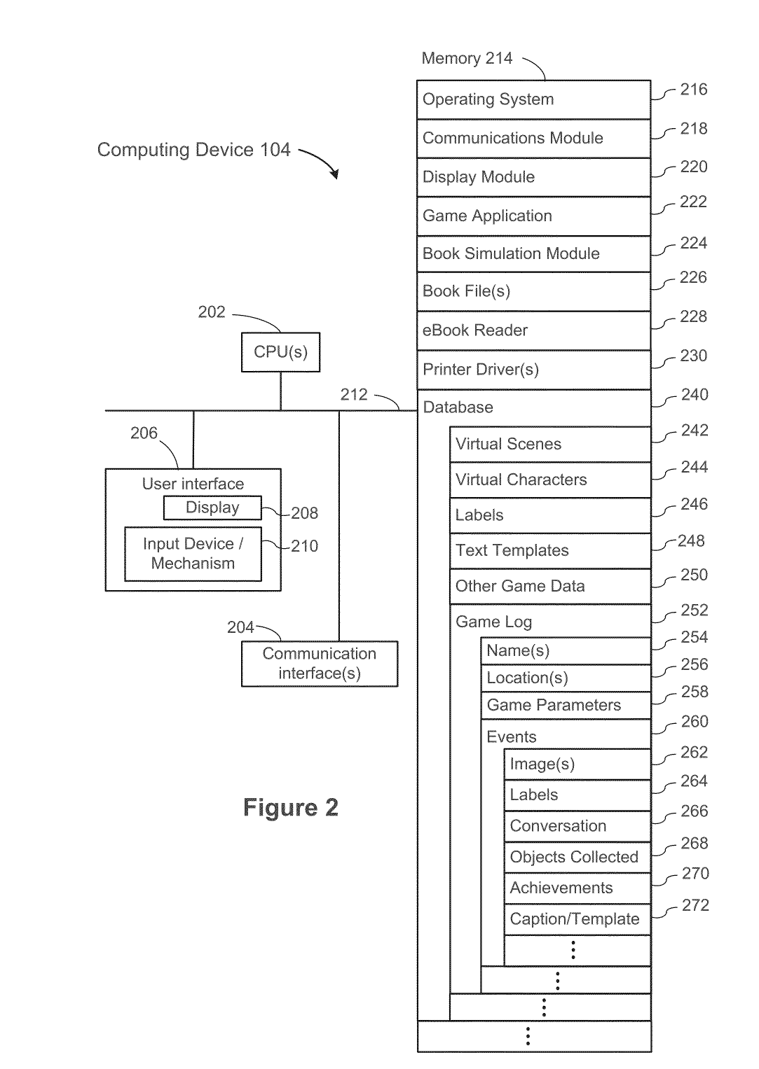

FIG. 2 is a block diagram illustrating a computing device 104, which a user 102 uses to access a game application 222. A computing device 104 is also referred to as a user device or a client device, which may be a tablet computer, a laptop computer, a smart phone, a desktop computer, a PDA, or other computing device that can run a gaming application 222. A computing device 104 typically includes one or more processing units (CPUs) 202 for executing modules, programs, or instructions stored in memory 214 and thereby performing processing operations; one or more network or other communications interfaces 204; memory 214; and one or more communication buses 212 for interconnecting these components. The communication buses 212 may include circuitry (sometimes called a chipset) that interconnects and controls communications between system components. A computing device 104 includes a user interface 206 comprising a display device 208 and one or more input devices or mechanisms 210. In some implementations, the input device/mechanism includes a keyboard and a mouse; in some implementations, the input device/mechanism includes a joystick, trackball, trackpad, voice activated controller, or touch screen display.

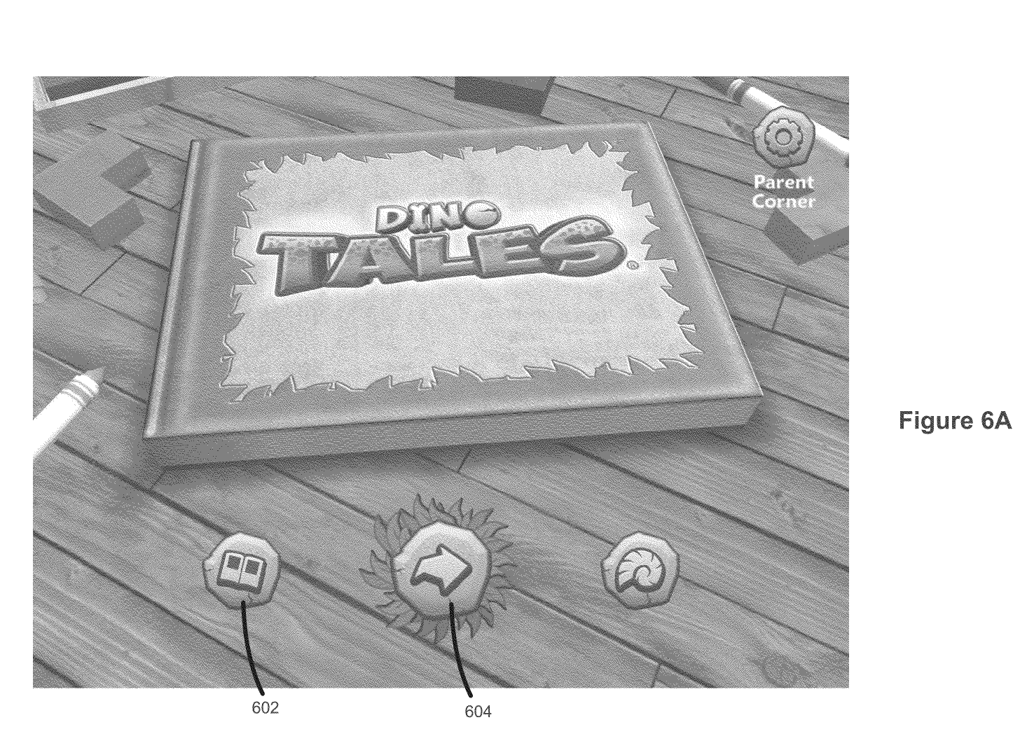

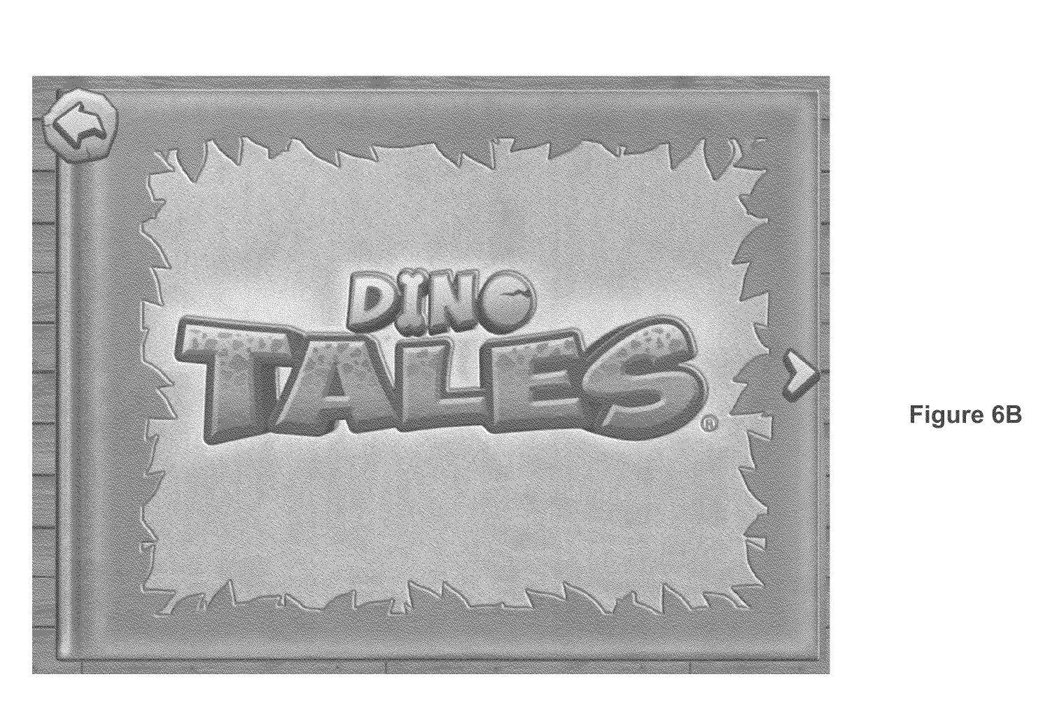

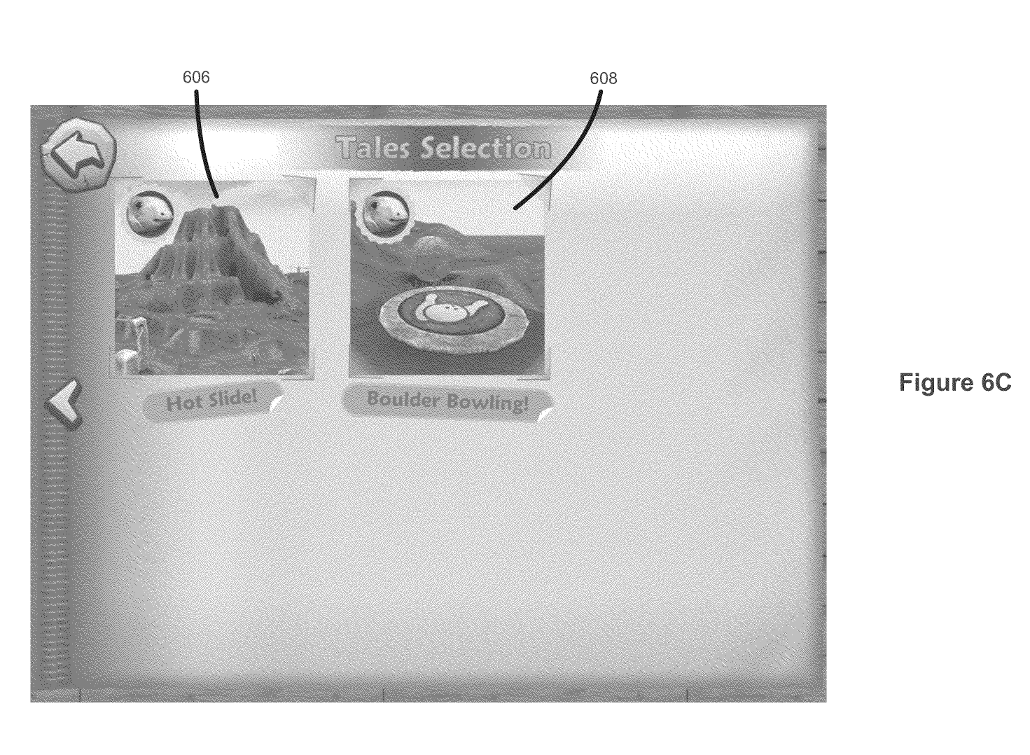

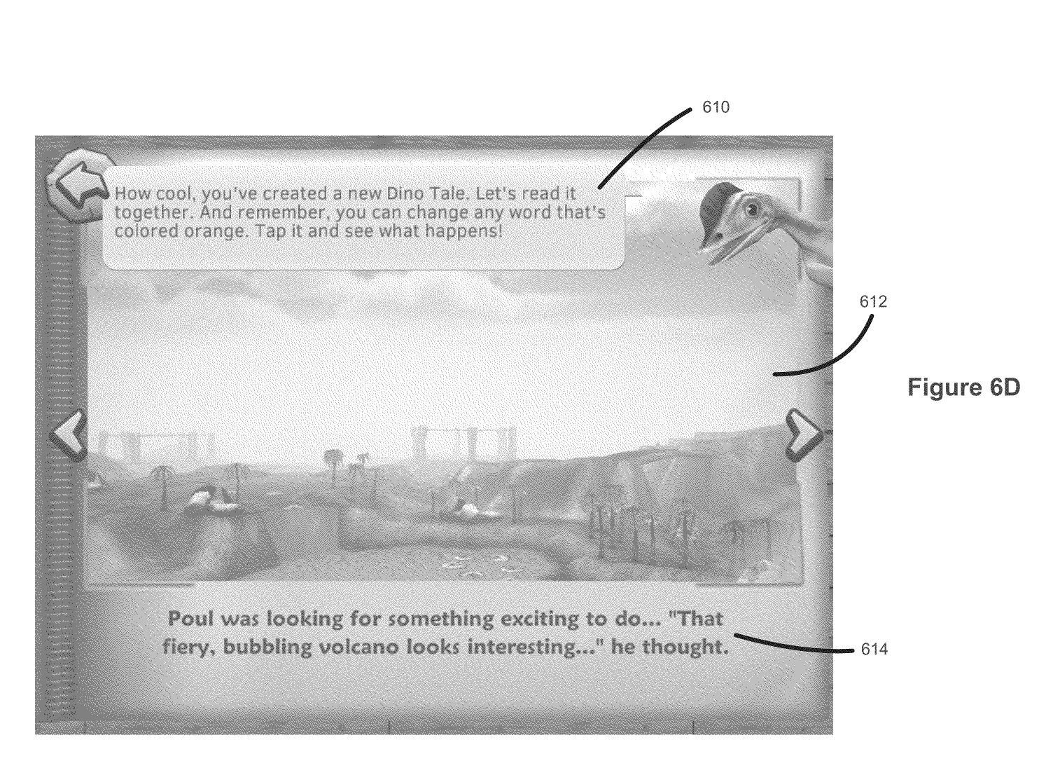

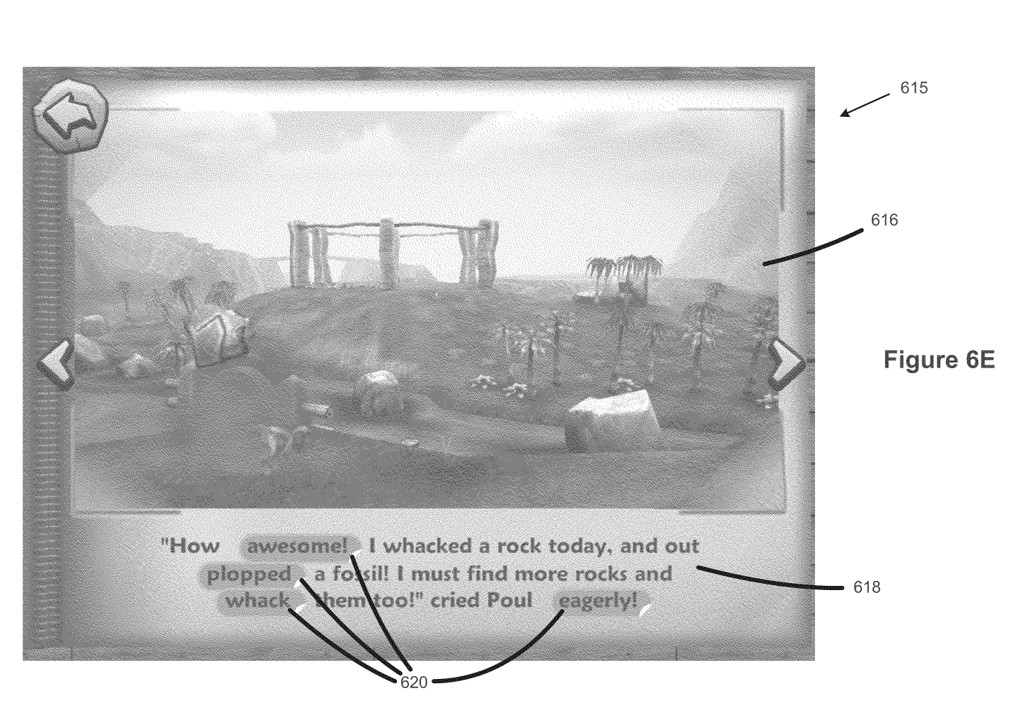

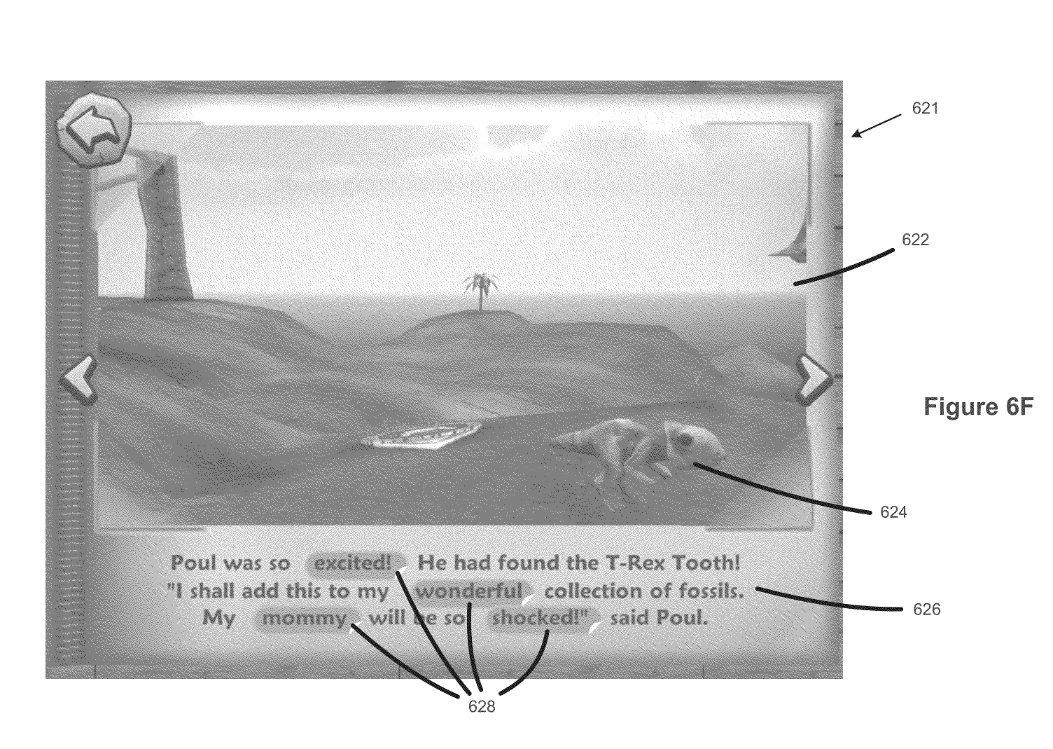

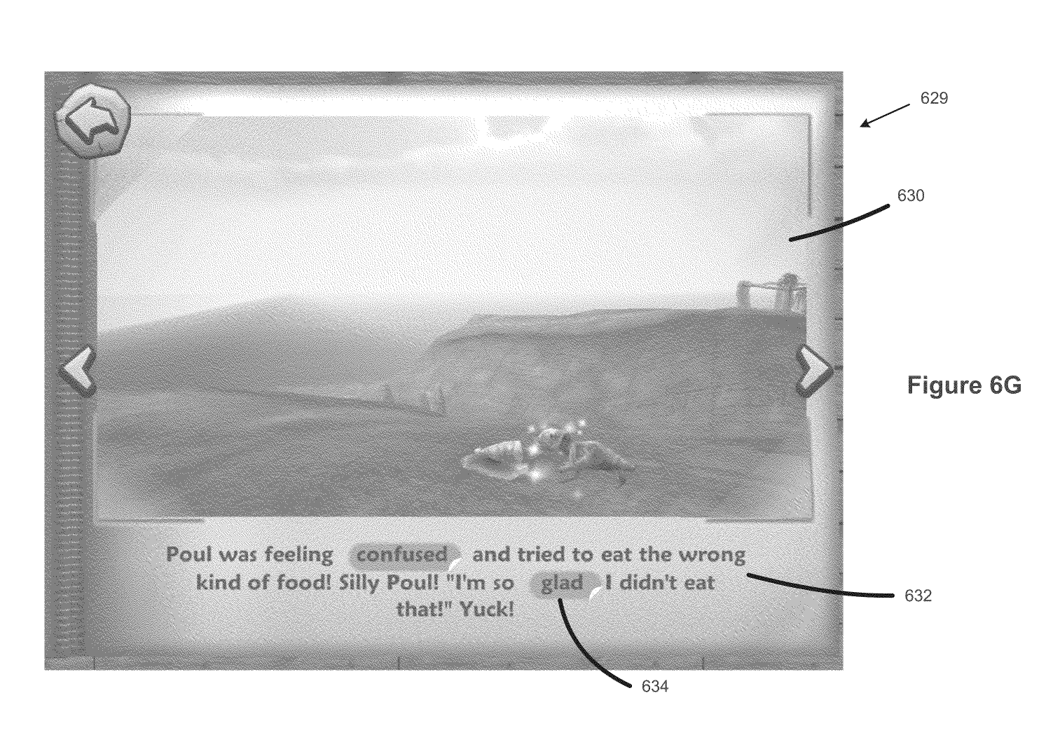

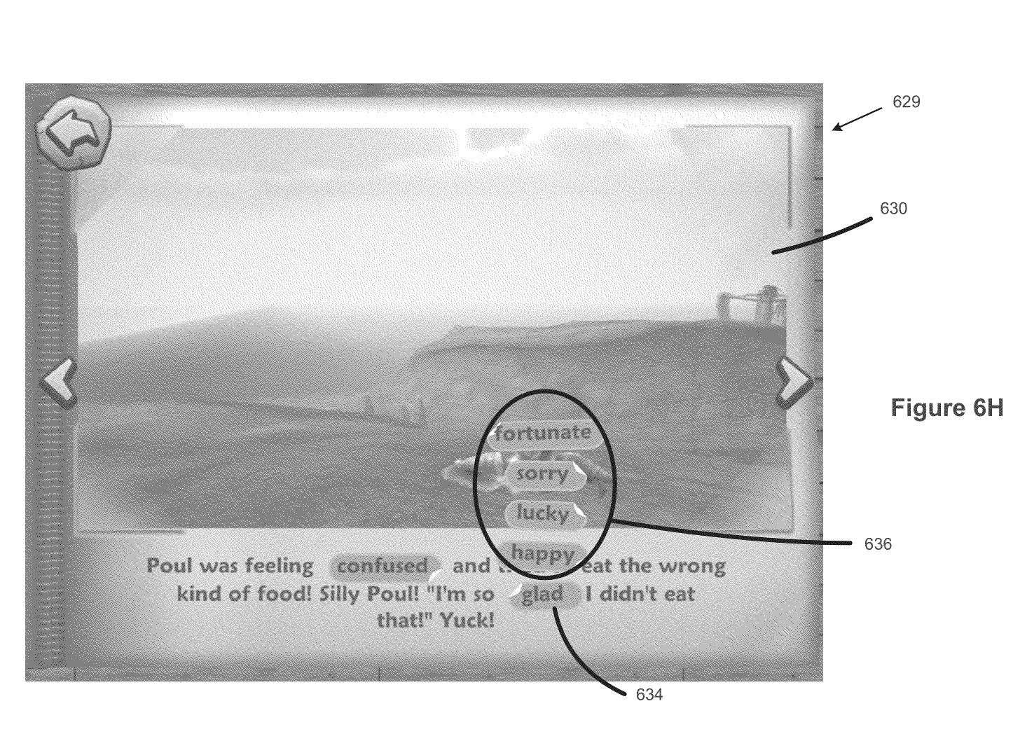

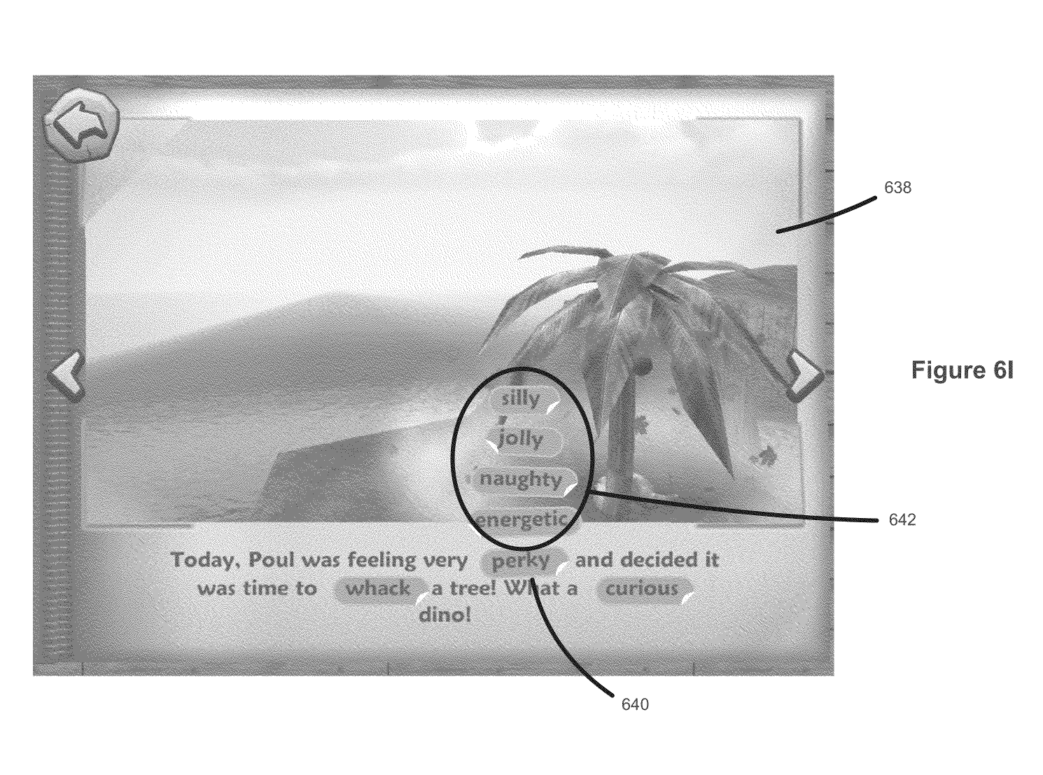

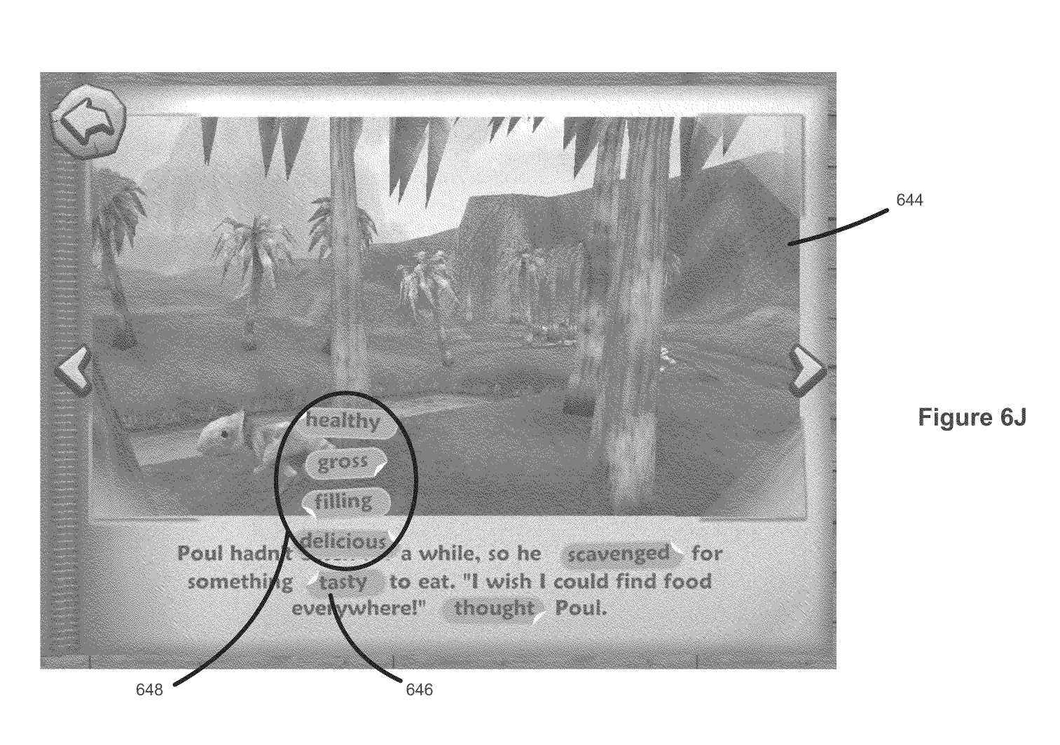

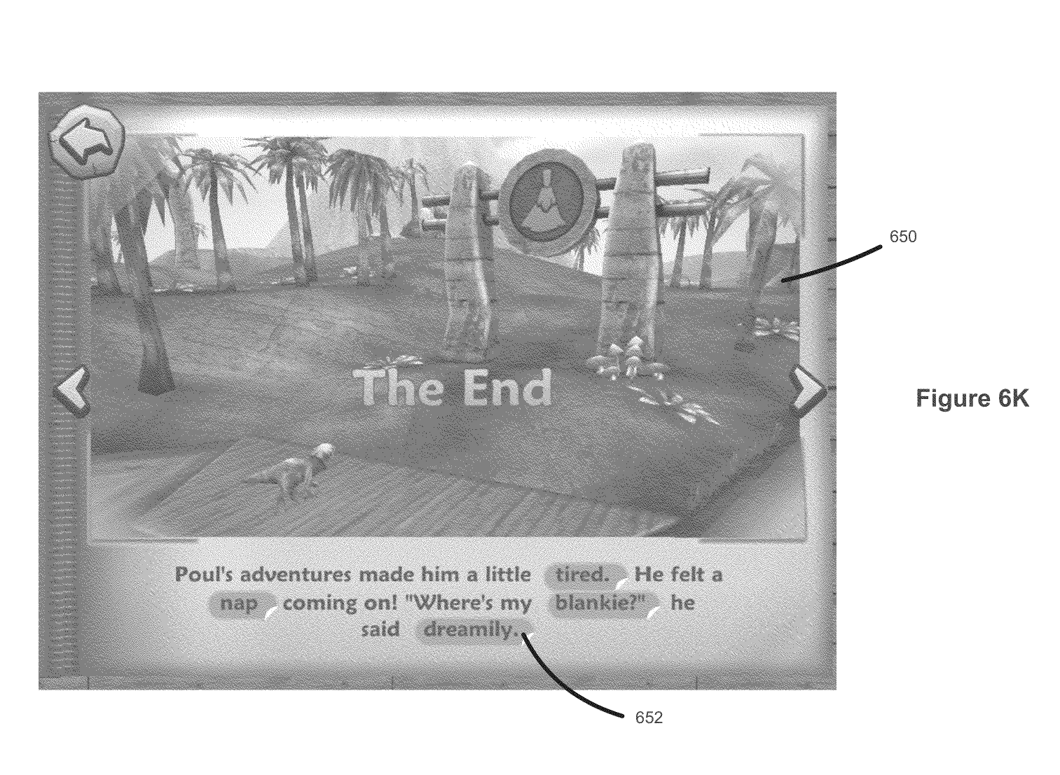

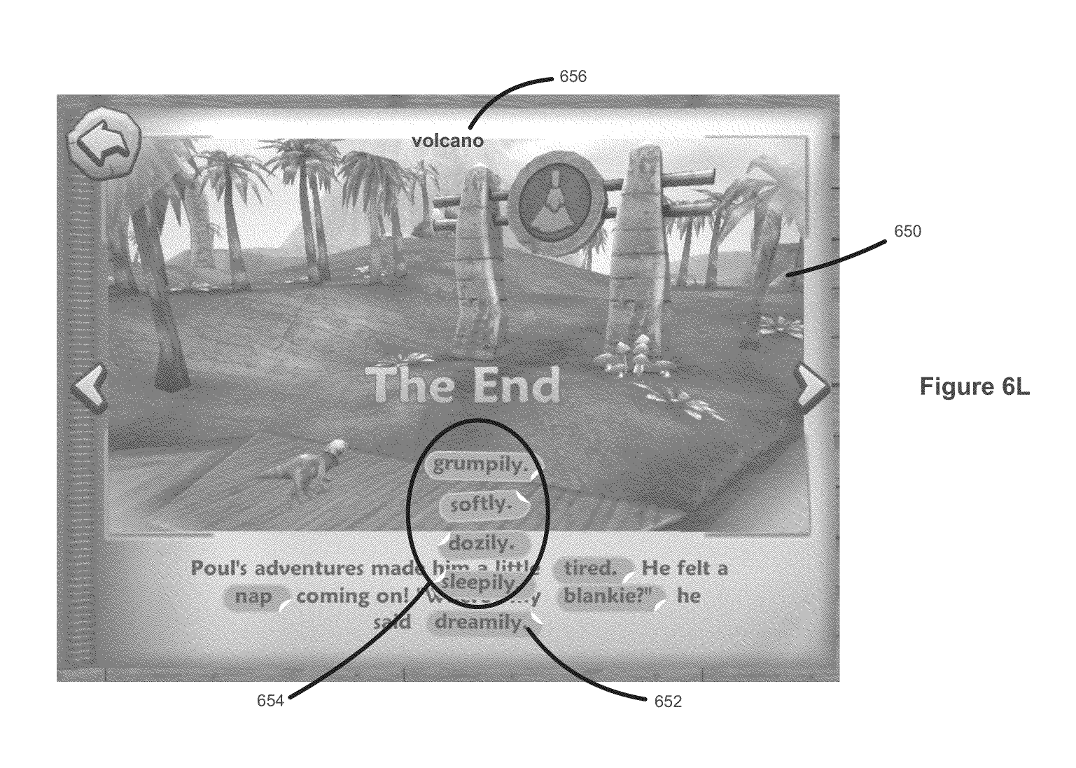

In some implementations, the memory 214 includes high-speed random access memory, such as DRAM, SRAM, DDR RAM or other random access solid state memory devices. In some implementations, the memory 214 includes non-volatile memory, such as one or more magnetic disk storage devices, optical disk storage devices, flash memory devices, or other non-volatile solid state storage devices. In some implementations, the memory 214 includes one or more storage devices remotely located from the CPU(s) 202. The memory 214, or alternately the non-volatile memory device(s) within the memory 214, comprises a non-transitory computer readable storage medium. In some implementations, the memory 214, or the computer readable storage medium of the memory 214, stores the following programs, modules, and data structures, or a subset thereof:
an operating system 216, which includes procedures for handling various basic system services and for performing hardware dependent tasks;
a communications module 218, which is used for connecting the computing device 104 to other computers and devices via the communication network interfaces 204 (wired or wireless) and one or more communication networks, such as the Internet, other wide area networks, local area networks, metropolitan area networks, and so on;
a display module 220, which receives input from the one or more input devices 210, and generates user interface elements for display on the display device 208;
a game application 222, which enables a user to manipulate a virtual character 244 within a virtual environment 110 provided by the game. The user 102 typically identifies with a single specific virtual character 244. The game application 222 may provide a sequence of virtual scenes 242, which may flow together or be discrete scenes. Within each scene, the user's virtual character 244 may interact with other virtual characters 244, or may interact with other virtual objects (e.g., collect virtual objects or have a conversation with another virtual character). During game play, the game application stores events 260 in a game log 252;
a book simulation module 224, which uses the events 260 stored during the game to build a digital book that includes images 262 from the events 260 as well as other data. In some implementations, the book simulation module 224 stores the digital book as a book file 226. In some implementations, a digital book may consist of a plurality of distinct files;
an eBook reader 228, which allows a user 102 to view a created digital book. In some implementations, the eBook reader 228 uses a standard format, such as an ePub or PDF. Some implementations support a proprietary format instead of, or in addition to, standard formats;
one or more printer drivers 230, which are used to create tangible books 108 (e.g., from a book file 226);
one or more databases 240, which store data and metadata. Some of the data and metadata is static (e.g., a predefined set of virtual scenes 242 and a predefined set of virtual characters 244). Some implementations enable a user to create new scenes 242 or new characters 244, or to modify existing scenes 242 or existing characters 244. Some implementations include a predefined set of labels 246, which may be used to identify various objects, characters, locations, and so on. Some implementations provide one or more text templates 248 corresponding to the virtual scenes 242. In some implementations, a text template includes certain fixed text corresponding to a scene and some words or phrases for which there are multiple alternatives. This is illustrated below in FIGS. 6E-6L. Typically, the game application 222 and book simulation module use other game data 250 as well;
the database stores a game log 252, which includes various information about each game played. In some implementations, the user 102 provides a name 254 for the user's character in the game, and may provide names 254 for other characters, objects, or locations as well. In some implementations, the user may assign other attributes of the characters as well, such as gender or age. For certain virtual characters, other attributes may be specified as well, such as hair color. In some implementations, a game may include predefined locations, which may have pre-assigned names or descriptions (e.g., Rabbit Hole). In some implementations, a user 102 can assign a name 254 to the predefined locations. In some implementations, the user can create additional locations and assign names to those locations (e.g., identify a certain position in a scene as “Picnic Spot” or identify a tree as “Owl's tree”). In some implementations, the game log includes other game parameters 258 for the game as well (e.g., a skill or age level, or user preferences); and
the game log 252 includes an ordered sequence of events 260, which track the user's interactions with the virtual environment 110. In some instances, an “event” may comprise a single interaction that occurs during a short period of time (e.g., a few seconds). In other instances, an “event” may represent a longer span of time (e.g., a few minutes) at a single scene. Each event includes one or more images 262, which visually depict the interaction(s). In some implementations, each event has a single associated image 262. In some implementations, an event includes one or more associated labels, which describe characters, objects, locations, or other features associated with the scene at the time the images are captured. This is described in more detail below with respect to FIGS. 5A-5F. In some implementations, an event can include a conversation between the user's character 244 and one or more other characters 244 in the scene. In some implementations, a user's character can collect objects 268 or achieve certain tasks, and these collections 268 or achievements 270 are recorded as part of the event 260. In some implementations, when an event is recorded, a caption 272 is assigned to the event 260. In some instances, the caption 272 is one of the predefined text templates 248.

Each of the above identified executable modules, applications, or sets of procedures may be stored in one or more of the previously mentioned memory devices and corresponds to a set of instructions for performing a function described above. The above identified modules or programs (i.e., sets of instructions) need not be implemented as separate software programs, procedures, or modules, and thus various subsets of these modules may be combined or otherwise re-arranged in various implementations. In some implementations, the memory 214 may store a subset of the modules and data structures identified above. Furthermore, the memory 214 may store additional modules or data structures not described above.

Although FIG. 2 shows a computing device 104, FIG. 2 is intended more as a functional description of the various features that may be present rather than as a structural schematic of the implementations described herein. In practice, and as recognized by those of ordinary skill in the art, items shown separately could be combined and some items could be separated.

In some implementations, the data or executable programs illustrated in FIG. 2 for the game application may be shared between the computing device 104 and one or more servers located remotely from the computing device. For example, a file 226 corresponding to a digital book may be transmitted to a server at a company that provides printing services. One of skill in the art recognizes that various allocations of functionality between the computing device 104 and one or more servers are possible, and some implementations support multiple configurations (e.g., based on user selection).

FIG. 3 illustrates a sequence of three scenes in a user interaction with a virtual environment 110. In the first scene 302-1, the user's character 244 has approached a door, and may have a key that unlocks the door. While the user plays the game, the game application records the event as a first event 260-1. The event is recorded without any action by the user to trigger saving the event. In this way, the user can just enjoy the game, and the game application 222 records events as appropriate. Some implementations also allow a user 102 to trigger the recording of an event at a specific time (e.g., by clicking a designated button in the user interface).

In some implementations, events are triggered automatically based on reaching or attaining certain milestones within the game, such as reaching the top of a mountain or volcano, collecting an object, reaching an achievement level, opening a door, and so on. Some implementations have a predefined set of milestones.

In some implementations, at least some of the events are triggered based on a timer. For example, if a certain amount of time has elapsed since the last event (e.g., five minutes), automatically record another event. In some implementations, multiple images are saved for at least some of the events, and the user is later able to decide which image(s) to use for the book that is created. In some implementations, images are recorded for each event at scheduled intervals, such as every 15 seconds. In some implementations, the user can trigger the capture of additional images, which may be stored together in a single event with other images that are captured automatically.

In the second scene 302-2, the user's character 244 is approaching a hole in the ground, and the game application 222 records the event as a second event 260-2, including the image of the scene. In some implementations, the hole is assigned a name or location identifier, which is included with the event.

In the third scene 302-3, the user's character 244 has a conversation with an animal, and the game application records the scene as a third event 260-3. The conversation in the third scene 302-3 is included with the recorded event 260-3.

All three of the events are stored in the database 240. Also stored in the database is the name “Jenny,” which the user 102 has assigned to the character 244. In some instances, the user 102 assigns his or her own name to the character. Although this illustration shows only three events, a typical sequence of recorded event for a game includes many more events (e.g., 10-50 events). In some implementations, multiple game sessions are combined (e.g., when the sessions have continuity, with a subsequent session beginning where a previous session left off).

FIG. 4 illustrates recording a scene and later displaying the scene and associated narrative text on a simulated page for inclusion in a digital book. The scene 302-i is recorded as an event 260-i during game play. After game play is over, the event 260-i, including the recorded image, are presented to the user 102 as a simulated page 402-i. In the simulated page 402-i, the caption “The robot ran down the corridor quickly” has been added, and certain words/phrases 404, 406, and 408 in the caption are designated as editable. In some implementations, the set of possible alternatives are predefined, and a user interaction with the editable term (e.g., clicking or tapping) brings up the list of alternatives. For example, in the simulated page 402-i, the user 102 has clicked on the editable phrase “ran down” 404, and the book simulation module 224 has brought up the alternative phrase list 410. The alternative phrase list may be presented in various ways, such as individual items shown in a vertical or horizontal arrangement, a menu list, rotatable tumblers, and so on. In some implementations, the user can also type in alternative text if the user wants something other than the presented options.

In some implementations, multimedia elements are stored as part of the recorded events as well. For example, some implementations include video clips from the game, which may show movement within the game, having a swordfight with an evil villain, and so on. In some implementations, the game application 222 includes audio segments, such as talking (e.g., a simulated voice) or sound effects. Some implementations include audio clips from the video game sounds. Some implementations also include video clips or audio clips from the user 102. For example, the user may yell “open sesame” to open a hidden passageway within the virtual environment, and those magic words may be recorded.

FIGS. 5A-5F provide a flowchart of a process 500 for building (502) a storybook of interactions with a virtual environment according to some implementations. The method is performed (504) at a computing device having one or more processors and memory storing one or more programs (e.g., a game application 222) configured for execution by the one or more processors. In a virtual game environment, a user dynamically controls the actions of a virtual character, as displayed on a display screen 208. Example images from a virtual game environment are shown in FIGS. 6D-6L below.

The game application 222 receives (506) user input to control actions of a virtual character 244 within the virtual game environment 110. The user 102 may control the actions of the virtual character using various input devices, such as a keyboard, mouse, joystick, trackball, trackpad, or touch screen. The virtual character 244 may be (508) a sentient being (e.g., a human-like creature), an artificial creature or machine (e.g., a robot or a spaceship), a non-sentient organism (e.g., a cell or bacterium), a mythical creature (e.g., a unicorn), or even an inanimate object (e.g., a water droplet). Before beginning the game, some implementations allow the user to select a virtual character, as well as various visual characteristics of the virtual character. For example, in a virtual environment with dinosaurs, the user may be able to select the type of dinosaur, the size or age of the dinosaur, as well as color, texture, or pattern of the dinosaur's body.

Typically, the process displays (510) the virtual game environment and the virtual character on a display device 208 associated with the computing device 104. In some implementations, the game application 222 displays (512) narrative text corresponding to the virtual scene that is displayed. In some of these implementations, the user may choose (514) to save the narrative text with a saved event (e.g., the most recently saved event or the next event to be saved). In some implementations, the user activates (514) this save of narrative text using a user interface control, such as a button or toggle. The activation occurs (514) during user interaction with the virtual game environment 110.

In some implementations, the user assigns (516) a name to the virtual character. In some implementations, the user assigns other attributes of the virtual character as well, such as gender or age. When the user assigns name, gender, age, or other characteristics, some implementations include these characteristics in the simulated pages.

During a game, the game application 222 records (518), without user input, a temporal sequence of events 260 from the game environment 110. The user may be interacting with the environment (e.g., moving the virtual character 244), but no user-action is required to trigger capturing and record the events. However, in some implementations, a user may trigger recording additional events when desired (e.g., by clicking on a user interface control).

Each event 260 represents (520) an interaction of the virtual character 244 with the game environment. The interaction recorded may represent a short period of time (e.g., the second that the user's character reaches the peak of a mountain), or may represent a longer period of time (e.g., having a conversation with another character or the process of climbing the mountain). Each event includes (522) a respective image 262 and respective text 272 describing the respective event. In some implementations, some of the events include (524) multiple images (e.g., two or more images that are captured in quick succession or multiple images of the same scene at the same time taken from different viewpoints).

In addition to the respective text 272, some implementations record (526) a separate caption or title for some of the recorded images 260 (e.g., “The adventure begins”). In some implementations, the separate caption or title is not editable by the user.

In some implementations, some events include (528) one or more labels that identify locations within the virtual game environment at the time the events are recorded. This is illustrated, for example, by the “volcano” label 656 in FIG. 6L. In some implementations, at least some of the events include (530) data that identifies the state of the virtual game environment 110 when the events are recorded. For example, the state of the game may include virtual objects 268 collected by the virtual character, achievements 270 of the virtual character, the health of the virtual character, the time of day in the virtual environment, the current location of the virtual character in the virtual environment, a point score (in games where the user's actions score points), and so on.

In some implementations, some of the events include (532) labels that identify other virtual characters or virtual objects within the virtual game environment 110 at the time the events are recorded. These labels may be predefined by the game application 222 or assigned by the user. For example, an implementation may include a T. Rex character, which has the default name “T. Rex,” but the user could assign another name.

In some implementations, some events include (534) a conversation between the virtual character and one or more other virtual characters within the virtual game environment at the time the events are recorded. This is illustrated above in the third scene 302-3 in FIG. 3. The recorded conversations indicate who the speakers are, what they said, and in what order the statements were made. In some implementations, the virtual character may have a conversation with an assistant or an object in the game. Such conversations may be recorded and included in the simulated pages as well.

In some implementations, some events include (536) one or more labels that identify virtual objects collected by the virtual character at the time the events are recorded. Some implementations store the collected objects as part of a recorded game state, but in other implementations, the information about objects is stored separately from a game state.

In some implementations, some events include (538) one or more labels that identify achievements of the virtual character at the time the events are recorded. Some implementations store the achievements as part of a recorded game state, but in other implementations, the information about achievements is stored separately from a game state.

The various labels that may be stored with an event can be combined. For example, in some implementations a first event includes (540) one or more labels that identify current game data at the time the first event is recorded. The current game data includes (540) one or more of: named locations within the virtual game environment; a state of the virtual game environment; other virtual characters or virtual objects within the virtual game environment; virtual objects collected by the virtual character; and achievements of the virtual character.

In some implementations, at least a subset of the events are automatically recorded (542), without human intervention, when the virtual character reaches a milestone in the virtual game environment. Typically, implementations have a predefined set of milestones, such as reaching specific locations, performing certain actions, collecting specific virtual objects, attaining certain achievement levels, and so on.

Subsequent to the recording, the book simulation module 224 presents (544) to the user a sequence of simulated pages that correspond to the sequence of recorded events. Each simulated page includes (546) the respective recorded image (or images) for a respective event and includes the respective text describing the event. In some implementations, the respective text is editable, so that the user 102 can customize the story that is created. In some implementations, individual words or phrases are designated as editable, and the book simulation module can provide alternatives for selected words or phrases. This is illustrated in FIGS. 6E-6L below.

In some implementations, some events have multiple images. These multiple images can be used in various ways. In some implementations, each event corresponds to a single simulated page, and each simulated page has a single image. In some of these implementations, the user is prompted to select which image is used. In some implementations, two or more images for a single event may be placed onto a single simulated page. The images may be selected by the user. In some implementations, when there are multiple images for a single event, the event corresponds to multiple simulated pages. In some implementations, each of the multiple images is presented on a distinct simulated page. In some implementations, the user is prompted to select which images to keep for simulated pages (e.g., for an event with five images, the user may select two of those images, and the book simulation module 224 creates a separate simulated page for each of the selected images).

In some implementations, a first event has a plurality of images and the corresponding simulated page includes (548) two or more of the multiple images 262. For example, an event may include two images taken close to each other in time, and both are displayed on the simulated page in order to illustrate a change that takes place between the two images (e.g., shooting an arrow in one image and having the arrow hit the target in a second image). In other examples, the two or more images 262 may illustrate different perspectives of the same scene, such as views of the scene as seen by two different virtual characters.

In some implementations where events can include more than one image 262, each simulated page includes (550) a single image. In this case, a single event may span multiple simulated pages.

In some implementations, the respective text for some simulated pages include (552) a plurality of text options, and the user selects one of the options. In some implementations, the text options apply to the text as a whole, but in other implementations, the text options apply to individual words or phrases within the text, as illustrated in FIGS. 6E-6L. Some implementations provide free-form text replacement options in addition to the predefined options.

Some implementations include (554) a user-provided name in the respective text on one or more of the simulated pages. For example, the user-provided name “Poul” appears in FIGS. 6D-6L. Typically the user-provided name indentifies the virtual character 244. In some implementations, the user 102 may provide names for other characters as well, and the other names may be included in the respective text for one or more events.

In addition to the respective text for each event, some implementations include (556) a separate caption or title for each image. In some implementations, the caption or title can be modified by the user. The caption or title is displayed (556) accompanying the corresponding image. In some implementations, the separate caption is narrative text that appears on the display while a user is interacting with the virtual game environment. In some implementations, a user can choose to save narrative text with an event using an interface control (e.g., a “save” or “record” button).

In some implementations, a first event corresponds (558) to a first simulated page, and presenting the first simulated page to the user includes (558) presenting a plurality of images as alternative options for the first simulated page. The book simulation module 224 then receives (560) user selection of a first image of the plurality of images. In this way users are able to choose images that best represent the stories that they want. In some implementations, a user can also choose to omit all images for some of the events. This can result in a “text only” simulated page or omission of the event from the created digital book.

In some implementations, one or more labels are displayed (562) on some of the simulated pages to identify locations corresponding to the labels. This is illustrated by the label “volcano” 656 in FIG. 6L. In some implementations, recorded data in displayed (564) on some pages to convey the state of the virtual game environment at the time the event was recorded.

In some implementations, one or more labels are displayed (566) on some simulated pages to identify other virtual characters or virtual objects. In some implementations, the labels are located adjacent to the corresponding virtual character or virtual object in a simulated page. In some implementations, the labels are connected to the corresponding virtual characters or virtual objects, or there are arrows pointing from the labels to the corresponding virtual characters or virtual objects.

In some implementations, a recorded conversation between the virtual character and one or more other virtual characters is displayed (568) in a textual format on a simulated page.

In some implementations, one or more labels are displayed (570) on some simulated pages to identify virtual objects collected by the virtual character. For example, at the time of an event, the virtual character may have collected a key that will be used later to open a door, so a label or icon representing the collected key may be included on the corresponding simulated page.

In some implementations, one or more labels are displayed (572) on some simulated pages to identify achievements of the virtual character. For example, the virtual character may be recognized for climbing a mountain or slaying a dragon.

Some implementations include (574) at least a portion of recorded narrative text in a simulated page corresponding to a first event. In some implementations, one or more labels that identify current game data at the time a first event was recorded are displayed (576) on a first simulated page.

In some implementations, the sequence of simulated pages includes (578) one or more simulated pages that includes graphics other than images recorded during game play. In some implementations, the graphics include (578) one or more of: a map of at least a portion of the virtual game environment, including a path on the map showing movement of the virtual character within the virtual game environment; a photograph of the user taken by a photo sensor associated with the computing device, where the photograph is taken during the user's interaction with the virtual game environment; an image of virtual objects collected by the virtual character; and an image depicting a certificate of achievement of the virtual character in the virtual game environment. In some implementations, the additional graphics can include clip art, other image files stored on the user's computing device 104, or other images publicly available on the Internet.

In some implementations, one or more simulated pages include (580) multimedia attachments. The multimedia attachments can include (580) one or more of: a video clip from the virtual game environment; an audio clip from the virtual game environment; a video clip of the user interacting with the virtual game environment; and an audio clip of the user interacting with the virtual game environment. Although these multimedia attachments may not be able to be included in a hard copy book, they may be included in a distributed digital book.

Some implementations provide one or more additional simulated pages to display other information related to the story without necessarily including an image for the virtual character's interaction with the game environment. Some implementations include a “status” page that provides various information about the virtual character in the environment. The status may be displayed using various combinations of text and graphics. Some implementations include a “collected items” page that shows visually the items the virtual character has collected. Some implementations include an “achievements” page that display certificates, awards, medals, badges, or other accomplishments by the virtual character. These additional simulated pages may occur at various points in the sequence of simulated pages, such as a point in time when the virtual character collects another object.

An important aspect of the disclosed process is that the user can create or modify the text that is displayed with each simulated page. In some implementations, the book simulation module 224 receives (582) user input to modify the respect text for at least a subset of the simulated pages.

Ultimately, the book simulation module generates (584) a file 226 that includes the sequence of simulated pages as modified by the user 102. In some implementations, the user has selected which images to use, and the user-selected images for at least a first simulated page are used (586) in the generated file.

In some implementations, the file 226 includes additional pages, such as a front cover, a copyright page, a dedication page, a table of contents, an index, chapter headers, and/or a back cover. For these additional pages, the user is prompted to provide or select appropriate text, such as a title. In some implementations, the file has (588) a file type that is one of JPEG, TIFF, BMP, PNG, PDF, EPUB, or MOBI.

In some implementations, a user 102 can create multiple book versions from a single set of events. For example, a user may save a first file 226, then use a “SAVE AS” feature to create one or more additional versions, which can be customized independently of the first saved version. Some implementations also enable a user to create new storybook files 226 based on two or more existing files. In this way, a user can combine interesting parts of multiple stories and omit parts that are not as interesting to the user.

In some implementations, the book simulation module 224 facilitates (590) printing the file 226 to create a tangible book that includes the simulated pages as modified by the user. In some instances, the created file 226 is transmitted to a publisher or bookbinder, which prints and binds a book corresponding to the file.

In some implementations, the book simulation module 224 transmits (592) the file to a remote book printing provider with instructions to ship a bound book corresponding to the file to a specified geographic address. The geographic address may be the address of the user, or the physical address of a friend or relative.

As illustrated in FIG. 1, some implementations transmit the generated file 226 to a remote server (e.g., a web server 130), which can then be transmitted to others or viewed by others digitally. Digital distribution may be instead of, or in addition to, printing of a hard copy.

The process 500 has been described for an implementation in which events are captured during game play and the pages for a corresponding storybook are created after the game play is over. Some implementations vary this overall process. For example, in some implementations, game play may extend over a longer period of time (e.g., days), and may comprise multiple distinct sessions. Some implementations enable a user to create a single storybook from these spread out sessions, particularly when the multiple sessions are conceptually part of a single story line.

In some implementations, the number of captured events may be very large, especially for a story that was constructed by a user over a period of days or weeks. In this case, some implementations allow a user to omit/delete some of the simulated pages so that they do not appear in the saved file 226.

Some implementations provide an integrated book-building feature or option, which allows a user to view and edit the simulated pages as the events occur, or shortly thereafter. For example, in an interactive video game with a plurality of discrete scenes, some implementations enable the user to build the book pages during the transition from one scene to the next scene.

FIGS. 6A-6L illustrate some features of one implementation. FIG. 6A illustrates an initial screen that may be used to introduce a player to the video game. Some implementations include a begin button 604 to begin an interactive game. Some implementations include a “book” button that enables a user 102 to view digital books created from previous interactions with the video game. FIG. 6B is an example of a “splash screen” that some implementations may use when beginning a game or reviewing saved digital books. FIG. 6C illustrates that some video games provide a selection screen, which may be used, for example, to read an existing digital book, or to select a storyline for a new game.

After a game is played, a default digital book may be created that uses the recorded images, captions, labels, and other data. FIG. 6D illustrates how a user is introduced to a saved digital book and invited to customize the content. In some implementations, the book simulation module 224 provides information 610 about how to edit the content. The first digital page includes an image 612 and caption 614 that begin the story. The caption 614 includes the user-assigned name “Poul” 254 for the virtual character in the story.

FIGS. 6E and 6F illustrate two simulated pages 615 and 621. The simulated page 615 includes an image 616 and corresponding caption 618 that describes the actions of the user's virtual character with respect to the image. In this case, the caption 618 includes several highlighted terms 620 that can be edited by the user. The user can initiate editing, for example, by clicking or tapping on the word or surrounding highlighting. The simulated page 621 in FIG. 6F includes a different image 622, which includes the user's virtual character 624. The caption 626 in FIG. 6F describes the character's actions, and has several highlighted terms 628 for the user to edit. In some implementations, the editable terms are highlighted in orange, and the highlighting may have a designated shape (e.g., a pill shape, as shown in FIGS. 6E and 6F).

FIGS. 6G and 6H illustrate how a user can edit highlighted text in some implementations. The simulated page 629 in FIGS. 6G and 6H includes an image 630 and a caption 632 that describes the scene in the image. The highlighted term 634 is editable. In FIG. 6H, the user has initiated editing the highlighted term “glad” 634 (e.g., by clicking or tapping on the “glad” term 634) and the book simulation module 224 brings up a list 636 of alternative words 636. In some instances, the original term and/or replacement options may be phrases, symbols, abbreviations, or other text strings, instead of single words, as illustrated above in FIG. 4. In some implementations, a user can select one of the presented options by tapping or clicking on the desired item. In some implementations, the list of alternatives includes an empty field that is editable, enabling a user to type in a word or phrase other than the presented options.

FIGS. 6I and 6J similarly illustrate providing alternative text for a selected highlighted word. As in the previous simulated pages, each of these simulated pages includes an image (638 and 644), an associated caption with a highlighted word (640 and 646), and a set of alternative words (642 and 648) that may be selected. As illustrated in FIG. 6J, some of the presented options may be humorous rather than synonyms of the selected term (e.g., scavenged for something “gross” to eat).

FIGS. 6K and 6L present the final simulated page in the digital book. Like the other simulated pages, the final simulated page includes an image 650 as well as a caption with editable terms, including the term “dreamily” 652. In FIG. 6L, the user has brought up the list 654 of alternatives to “dreamily” 652.

The screenshots in FIGS. 6A-6L illustrate some features according to the disclosure, but do not depict all of the disclosed features as described in the present application.

Some implementations enable a user to associate each potential location with a label. For example, the label #rabbitHole may be used to identify a virtual rabbit hole in the game. When the user moves the virtual character into the vicinity of the rabbit hole, the #rabbitHole label is added to the set of stored labels. In some implementations, the user may assign a custom label to a location. In addition, an image of the user's view of the location is captured and associated with that label, and recorded in the game log 252. Furthermore, other information about the state of the game, such as names of elements within the user's view, other characters, or the simulated time, are captured and associated with that label in storage. The label, image, and data form an event, and may be encapsulated as one unified element in data storage.

In some implementations, a label is associated with an activity in the game, such as the opening of a virtual door. For example, if the user manipulates the virtual character to open the door (e.g., turning a knob or key), the data for the unified event is recorded. The data may include a label, such as #wardrobeDoor or a custom label.

In some implementations, a label may be associated with the collecting of an item (or items) in the game. For example, the label #berry may be associated with a particular virtual berry in the game. If the user collects the virtual berry, the data for that unified event is recorded in the game log 252.

In some implementations, a label may be associated with the interaction between a user's character and a conversational agent (e.g., another character). The user's character may ask questions or answer questions, and the entire conversation is recorded as part of an event. For example, the label #howOld may be associated with a question or set of questions asked by the user's character.

In some implementations, a label may be associated with the accomplishment of a goal, task or mission. The accomplishment by the virtual character leads to the achievement of an award within the game. For example, the label #climbedVolcano may be associated with the goal of climbing a virtual volcano within the game. If the user achieves the goal (i.e., the virtual character in the game climbs the volcano), the data for that unified event is recorded in the game log 252.

In some implementations, each label is associated with a textual component that provides a template 248 for a caption to be associated with an image. In some implementations, the template is represented as a sequence of words, separated by punctuation to indicate which elements of the paragraph are fixed and which elements have alternatives. In other implementations, the template is represented by an XML document that is isomorphic with the punctuated sequence of words. For example, the sequence of words that corresponds to FIG. 4 may be “The robot {ran down|trundled along|passed through|fell down|waddled along} the {corridor|passageway|hallway|tunnel|shaft} {quickly|swiftly|slowly|rapidly|clumsily}.”

The user may select to view the recording of the interactions (events) within the game, and this is presented to the user as a set of simulated pages from a virtual book. On each page is a rendering of the image corresponding to the event, accompanied by a paragraph caption that provides a narrative description of the event. The caption is associated with one or more labels that corresponds to the event, and may be represented within the game using one of the implementations described above. The user may interact with the language of the paragraph, by making choices of alternative words as illustrated in FIGS. 6A-6L. These alternatives may appear in the form of a menu, a list, a wheel (e.g., a rotatable tumbler for selecting a desired word or phrase), or other design. Using this mechanism, the user is able to modify the meaning and intent of the caption to make it the user's own personal representation of the event.

In addition to page captions, some implementations also render the captured user activity associated with each recorded event. For example, in the case of a recorded event that corresponds to an interaction with a conversational agent, the questions addressed to the agent, along with their responses, may be rendered on the page.

In some implementations, the final step is the production of a printable format of the book that can be printed or shared with others via available electronic and digital communication mechanisms.

In some implementations, after a digital book is created, a user may read the book aloud and record the reading as part of the digital book. For example, a child may create a book representing the interaction with the game, narrate the book, and transmit a copy to a grandmother, who can see the images and hear the story as read by the grandchild. In some implementations, a user can repeat the recording of the audio multiple times so that the user can save a good recording. In some implementations, audio recordings can be created after the digital book is created and distributed. Note that the audio narration can be created by anyone, and not necessarily the user who created the interaction for the book. In some implementations, attached audio files are created for each page separately. In other implementations, each digital book can have a single audio file.

The terminology used herein is for the purpose of describing particular implementations only and is not intended to be limiting of the invention. As used in the description and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

The foregoing description, for purpose of explanation, has been described with reference to specific implementations. However, the illustrative discussions above are not intended to be exhaustive or to limit the invention to the precise forms disclosed. Many modifications and variations are possible in view of the above teachings. The implementations described herein were chosen and described in order to explain the principles of the invention and its practical applications, to thereby enable others skilled in the art to best utilize the invention and various implementations with various modifications as are suited to the particular use contemplated.

What is claimed is:

1. A method for creating storybooks corresponding to user interactions with a virtual game environment, comprising:
at a computing device having one or more processors and memory storing one or more programs configured for execution by the one or more processors:
receiving user input to control actions of a virtual character within the virtual game environment;
recording, without user input, a temporal sequence of events from the virtual game environment, wherein each event represents an interaction of the virtual character with the virtual game environment, and each event includes a respective image and respective text describing the respective event;
subsequent to the recording, presenting to the user a sequence of simulated pages corresponding to the sequence of events, wherein each simulated page includes at least a portion of the respective recorded image for a respective event and includes at least a portion of the respective text describing the event;
for at least a subset of the simulated pages, receiving user input to modify at least a portion of the respective text; and
generating a file that includes the sequence of simulated pages as modified by the user.

2. The method of claim 1, further comprising facilitating a printing of the file to create a tangible book that includes the simulated pages as modified by the user.

3. The method of claim 1, further comprising transmitting the file to a remote book printing provider with instructions to ship a bound book corresponding to the file to a specified geographic address.

4. The method of claim 1, further comprising displaying the virtual game environment and the virtual character on a display device associated with the computing device.

5. The method of claim 4, wherein displaying the virtual game environment includes displaying respective narrative text corresponding to a respective displayed virtual scene.

6. The method of claim 5, further comprising receiving user activation of a user interface control to include the respective narrative text with a first event, wherein the activation occurs during user interaction with the virtual game environment; and
including at least a portion of the respective narrative text in a simulated page corresponding to the first event.

7. The method of claim 1, wherein a first event includes a plurality of images.

8. The method of claim 7, wherein the first event corresponds to a first simulated page, the method further comprising:
while presenting the first simulated page to the user:
presenting the plurality of images as alternative options for the first simulated page; and
receiving user selection of a first image of the plurality of images; and
using the selected first image for the first simulated page in the generated file.

9. The method of claim 5, wherein the first event corresponds to a first simulated page, and the first simulated page includes two or more of the plurality of images.

10. The method of claim 5, wherein the first event corresponds to a plurality of simulated pages, and each simulated page in the plurality of simulated pages includes a respective one of the plurality of images.

11. The method of claim 1, wherein the respective text for a first simulated page includes a plurality of text options, and wherein receiving user input to modify the respective text comprises receiving a user selection of one of the plurality of text options.

12. The method of claim 1, further comprising:
receiving a user-provided name for the virtual character; and
including the user-provided name in the respective text on one or more of the simulated pages, wherein the user-provided name identifies the virtual character.

13. The method of claim 1, wherein a first event includes a respective caption, distinct from the respective text describing the respective event, and wherein the respective caption, as modified by the user, is displayed accompanying the respective image in a respective simulated page.

14. The method of claim 1, wherein a first event includes one or more labels that identify locations within the virtual game environment when the first event is recorded, and wherein the one or more labels are displayed on a first simulated page to identify the locations.

15. The method of claim 1, wherein a first event includes data that identifies a state of the virtual game environment when the first event is recorded, and wherein the data is displayed on a first simulated page to convey the state of the virtual game environment.

16. The method of claim 1, wherein a first event includes one or more labels that identify other virtual characters or virtual objects within the virtual game environment when the first event is recorded, and wherein the one or more labels are displayed on a first simulated page to identify the other virtual characters or virtual objects.

17. The method of claim 1, wherein a first event includes a conversation between the virtual character and one or more other virtual characters within the virtual game environment at the time the first event is recorded, and wherein the conversation is displayed in a textual format on a first simulated page.

18. The method of claim 1, wherein a first event includes one or more labels that identify virtual objects collected by the virtual character when the first event is recorded, and wherein the one or more labels are displayed on a first simulated page to identify the objects collected.

19. The method of claim 1, wherein a first event includes one or more labels that identify achievements of the virtual character when the first event is recorded, and wherein the one or more labels are displayed on a first simulated page to identify the achievements.

20. The method of claim 1, wherein a first event includes one or more labels that identify current game data at the time the first event is recorded, wherein the one or more labels are displayed on a first simulated page, and wherein the current game data is selected from the group consisting of:
named locations within the virtual game environment;
a state of the virtual game environment;
other virtual characters or virtual objects within the virtual game environment;
virtual objects collected by the virtual character; and
achievements of the virtual character.

21. The method of claim 1, wherein the sequence of simulated pages includes one or more simulated pages that includes a graphic selected from the group consisting of:
a map of at least a portion of the virtual game environment, including a path on the map showing movement of the virtual character within the virtual game environment;
a photograph of the user taken by a photo sensor associated with the computing device, wherein the photograph is taken during the user's interaction with the virtual game environment;
an image of virtual objects collected by the virtual character; and
an image depicting a certificate of achievement of the virtual character in the virtual game environment.

22. The method of claim 1, wherein one or more simulated pages include multimedia attachments selected from the group consisting of:
a video clip from the virtual game environment;
an audio clip from the virtual game environment;
a video clip of the user interacting with the virtual game environment; and
an audio clip of the user interacting with the virtual game environment.

23. The method of claim 1, wherein at least a subset of the events are automatically recorded, without human intervention, when the virtual character reaches a milestone in the virtual game environment.

24. A computing device, comprising:
one or more processors;
memory; and
one or more programs stored in the memory configured for execution by the one or more processors, the one or more programs comprising instructions for:
receiving user input to control actions of a virtual character within the virtual game environment;
recording, without user input, a temporal sequence of events from the virtual game environment, wherein each event represents an interaction of the virtual character with the virtual game environment, and each event includes a respective image and respective text describing the respective event;
subsequent to the recording, presenting to the user a sequence of simulated pages corresponding to the sequence of events, wherein each simulated page includes at least a portion of the respective recorded image for a respective event and includes at least a portion of the respective text describing the event;
for at least a subset of the simulated pages, receiving user input to modify at least a portion of the respective text; and
generating a file that includes the sequence of simulated pages as modified by the user.

25. A non-transitory computer readable storage medium storing one or more programs configured for execution by a computing device having one or more processors and memory, the one or more programs comprising instructions for:
receiving user input to control actions of a virtual character within the virtual game environment;
recording, without user input, a temporal sequence of events from the virtual game environment, wherein each event represents an interaction of the virtual character with the virtual game environment, and each event includes a respective image and respective text describing the respective event;
subsequent to the recording, presenting to the user a sequence of simulated pages corresponding to the sequence of events, wherein each simulated page includes at least a portion of the respective recorded image for a respective event and includes at least a portion of the respective text describing the event;
for at least a subset of the simulated pages, receiving user input to modify at least a portion of the respective text; and
generating a file that includes the sequence of simulated pages as modified by the user.
